(19) United States
(12) Patent Application Publication
(10) Pub. No.: US 2014/0045152 A1
(43) Pub. Date: Feb. 13, 2014

(54) Method and system of computer based and software directed educational therapy employing video games to treat the effects of dyslexia and reading disabilities

(71) Applicant: William Vincent Madigan, Atlanta, GA (US)

(72) Inventor: William Vincent Madigan, Atlanta, GA (US)

(21) Appl. No.: 13/950,377

(22) Filed: Jul. 25, 2013

Related U.S. Application Data
(60) Provisional application No. 61/682,157, filed on Aug. 10, 2012.

(51) Int. Cl. G09B 17/00

(52) U.S. Cl. CPC G09B 17/003
USPC 434/169

(57) ABSTRACT

A process and method for providing a dyslexic individual with prerequisite skills that must be in place prior to beginning the process of learning to read and general reading skills necessary in order to learn how to read are described herein. The software directed educational therapy of the embodied invention is provided using a computer or other device, in a game format that entertains and builds cognitive, phonological, encoding, decoding and comprehension skills. The embodied invention also directs and controls the users educational therapy by the construction of the games and restricting access to games only to users who have successfully completed earlier games in an area, access to levels to those who have successfully completed all previous games in a lower level providing high degree of likelihood of developing all required prerequisite and reading skills at the highest levels in the least amount of time and the lowest expense.

### CROSS REFERENCE TO RELATED APPLICATIONS

The present application claims the benefit of U.S. Provisional Patent Application No. 61/682,157, filed on Aug. 10, 2013, which is incorporated herein by reference.

### REFERENCES CITED

### US Patent Documents

61/682,157 August 2012 Madigan (Provisional) Web-based Educational Therapy Program

### Patent Classifications

| Int. Class | G098 17/00 |
|---|---|
| U.S. Class | 434/178, 434/169, 434/156. 434/159, |
| | 434/160, 434/167, 434/172, |

### Other Documents

Overcoming Dyslexia by Dr. Sally Shaywitz M.D., First Vintage Books

### BACKGROUND OF THE INVENTION

The invention is directed to the fields of invention specifically the fields of teaching, education, neurology, psychology, psychoeducational evaluation, educational therapy, system and method engineering, video game creation and more particularly, to a system and method for remediating dyslexia and reading disabilities remotely from the dyslexic by the use of digital educational therapy that provides a unique combination and comingling of said fields delivered via the web or other electronic means.

In the field of education, there are public and private school systems that provide educational services to their students. These systems make assumptions about their students possession of prerequisite reading skills and readiness to learn the reading process. As a result schools do not teach prerequisite reading skills and teach all students as if they possessed such skill which leads to a disconnection of fifteen to eighteen percent of their students to the reading process. Because school systems are based on incorrect assumptions they have no capacity to remediate the dyslexic or reading disabled and typically use retention and or accommodation as a strategy in dealing with the condition.

To improve this condition this invention pertains to a system to remediate dyslexia and reading disabilities using cognitive, phonological, encoding, decoding and comprehension based assessment, cognitive, phonological, encoding, decoding and comprehension skills training specifically in the area of prerequisite reading skills, reading skills and dyslexia. More particularly, this invention pertains to a digital educational therapy program, or reading education program, that provides cognitive, phonological, encoding, decoding and comprehension assessments and training programs for identifying cognitive, phonological, encoding, decoding and comprehension strengths and identifying and treating the cognitive, phonological, encoding, decoding and comprehension weaknesses of an individual for the purposes of providing an individual with prerequisite reading skills and of teaching said individual to use those skills to read and controlling the scope and sequence of that treatment with computer software.

In order to successfully and efficiently help the dyslexic overcome their condition this invention draws on the fields of neurology, psychiatry, psychology, psychometrics, educational therapy, teaching, computer science, video game creation and process and systems control to address dyslexia in a way that each of the these individual fields has been unable to do.

### BRIEF SUMMARY OF THE INVENTION

A digital educational therapy program, or reading education program, providing prerequisite and general cognitive, phonological, encoding, decoding and comprehension assessment and training programs for identifying prerequisite and general cognitive, phonological, encoding, decoding and comprehension strengths and weaknesses of an individual and teaching prerequisite and general cognitive, phonological, encoding, decoding and comprehension skills to the individual and instructing the individual in how to use those skills to teach the individual user to read. A computer, hand held device, cell phone or other device and on-line gaming environment that provides cognitive, phonological, encoding, decoding and comprehension assessment and training. Prerequisite cognitive, phonological, encoding, decoding and comprehension skills differ from general reading skills and must be in place prior to initiating the system and method of learning to read. Reading skills are dependent on these prerequisite cognitive, phonological, encoding, decoding and comprehension skills. Reading cannot develop normally and adequately without these cognitive and phonological skills.

A computer, hand held device, cell phone or other device using a game format provides educational therapy to simultaneously, sequentially, and cumulatively entertain and build prerequisite and general cognitive, phonological, encoding, decoding and comprehension skills and teach reading.

Each game within this digital educational therapy platform is identified and accessed by a code that is provided upon successful completion of the next lowest game in a specific area. Additionally, skill areas and skill levels are interrelated so that a game in a particular area and at a particular level must be completed as a prerequisite to proceeding to the next higher level game thereby controlling and directing the user's therapy program. The linking of games, skill areas and skill levels provides for an improved likelihood of developing all required prerequisite and general reading skills in an efficient sequence to the highest levels possible.

Other systems, methods, features and advantages of the present invention will be or become apparent to one with skill in the art upon examination of the following drawings and detailed description. It is intended that all such additional systems, methods, features and advantages be included within this description and be within the scope of the present disclosure.

### BRIEF DESCRIPTION OF THE DRAWINGS

The above-mentioned features will become more clearly understood from the following detailed description read together with the drawings in which:

FIG. 1 Illustrates the configuration of an individual game. This general configuration would be typical of other games in the eight areas of cognitive, phonological, encoding, decoding and comprehension skills development as well other levels of the platform but may change from time to time in sequence and content as the intended purpose warrants. Each game would contain a section consisting of the user entering an entry code, an instruction/training section and one or more sections containing a Repeat/Evaluate/Redirect step. The content of each game would change, as would the level of difficulty and or modality and other aspects as would be appropriate to the skill or content being taught. The drawing also shows the ability of each game to move the user both forward and backward depending on the user's success or failure in acquiring the specific skill or information the game is designed to teach, thereby controlling the user's therapy program within the game. FIG. 1 also illustrates the use of an Exit Code supplied to the user upon successful completion of a game, this code becomes an entry code for the next game in a sequence thereby controlling the user's movement from game to game.

FIG. 2 Illustrates a progression of games as described in FIG. 1 in one specific area at one specific level and demonstrates the sequential nature of a series of five games in a specific area and level and how Entry Codes and Exit Codes link them. In this practice the Exit Code provided at the end of a game becomes and is the Entry Code for the next game in the corresponding area and level so as to compel the user to successfully complete each proceeding game in an area and to move through all five of the games in the area in a specific order to arrive at an Exit Code at the end of game five in that area further controlling the users therapy program. This fifth Exit Code is to be entered in the appropriate area in a following Portal area (see FIG. 3). This sequencing however does not preclude the user from returning to completed games for review and reinforcement at any time.

FIG. 3 Illustrates a group of games as illustrated in FIG. 1 grouped into eight areas as illustrated in FIG. 2 comprising a level consisting or forty sequenced games five each in eight areas illustrated as Level 1 as well as a Portal and second level represented as Level 2. Within a level and between levels the prerequisite skills and reading skill being taught can be related so that reinforcement takes place within a game, across areas and levels. Each area in the invention is represented by one of eight characters shown (Harmony, Swift, Optic, Tactile, Bamboozle, Recall, Array, Audio). Further FIG. 3 also illustrates the function of a Portal in which all of the eight Exit Codes from the fifth game in each of the eight areas are correctly entered in that portal which will then generate eight Entry Codes for the first eight games in each of the eight corresponding areas in the next highest level thereby further controlling the users therapy program and ensuring that the games are completed at a particular level prior to access being provided to the next higher level.

This aspect of the invention guarantees that the user will not be able to skip a game, area or a level and will gain prerequisite and reading skills in a controlled sequential way to ensure that the greatest amount of skill building progress is achieved. There is no limitation on the number of levels and portals that can be employed and the total number of levels and portals is dependent on the complexity of the scope and sequence of the cognitive, phonological, encoding, decoding and comprehension assessment and training taking place.

FIG. 4 Illustrates the two embodiments of the implementation and distribution of the digital educational therapy program. In the first embodiment a software program is accessed by a user directly from a web server through a website on the internet to the users computer, hand held device, cell phone or other device. In the second embodiment the software is distributed directly to a computer, hand held device, cell phone or other device from a universal serial bus device, disk or other device as is appropriate. These illustrations are only two embodiments of the invention and other means of implementation can be used.

FIG. 5 Illustrates a table mapping prerequisite skills, reading skills, linguistic and cognitive and phonological skills and shows their impact and relevance to each character and area of the invented digital educational therapy program. FIG. 5 also demonstrates that areas and the prerequisite and reading skills that they are developing can and do overlap so that an area and the games they are comprised of are actually teaching more than one prerequisite and or reading skill.

FIG. 6 Illustrates a single page of a multi page “codebook” which is used by the digital educational therapy user to track codes in all areas and portals and is used to incentivize the educational therapy process.

### DETAILED DESCRIPTION OF THE INVENTION

Dyslexia is a neuropsychological disorder that affects reading, and spelling. In the mid nineteen nineties evidence began to emerge as evidenced by a study by Dr. S. Shaywitz M.D. and documented in her book “Overcoming Dyslexia” that dyslexics actually use different parts of their brains to read with than non dyslexics. Dyslexia is a very complex condition with each dyslexic's condition being driven by a set of unique causes and each dyslexic exhibiting somewhat different effects thus making it difficult for the dyslexic to learn to read within a school system.

Dyslexia can be broken into three predominant categories;
1) Dyseidetic dyslexia is a condition in which an individual cannot read (decode) and or spell (encode) because he or she is unable to remember whole, irregular sight words (also known as eidetic words) this condition is known as Dyseidetic Dyslexia. In this condition, the Angular Gyrus of the left parietal lobe of the brain is affected. The person will have poor sight word recognition, relies on sounding words out, and reading is slow and laborious. Irregular words are sounded out phonetically (ex. laugh=log) and all words are spelled phonetically (ex. ready=rede).
2) Dysphonetic dyslexia is a condition in which the individual cannot read (decode) and or spell (encode) because he or she is unable to break phonetically regular words (also known as phonetic words) down into their sound parts, this condition is known as Dysphonetic Dyslexia. In this condition, the Wernicke's Area of the left temporal and parietal lobes of the brain is affected. The person will rely on sight word recognition, cannot sound out unknown words, either knows a word or does not, substitutes or skips words a lot, memorizes words, and cannot spell by sounds.
3) Dysphoneidetic dyslexia is a condition in which the individual cannot read (decode) and spell (encode) words, whether eidetically or phonetically, this is also known as Mixed Dyslexia. This is the severest form of dyslexia because it involves both types of coding functions. In dysphoneidetic dyslexia, the Angular Gyrus and Wernicke's Area are affected. These individuals experience difficulties consisting of both of the types explained above.

By definition dyslexics use a different portion of their brains to read with then non dyslexics and it is physically impossible to change that function therefore it can be said by one with knowledge in the art of medicine that dyslexia as a medical condition cannot be cured. However, what can be treated and reversed is the weakness or lack of cognitive, phonological, encoding, decoding and comprehension prerequisite skills associated with the dyslexic condition. This process is accomplished by building appropriate neural pathways in the brain, these pathways are defined as links between neurons that “wire” the brain so that the brain can control different body functions and thinking processes. By building specific neural pathways with educational therapy the invention provides the dyslexic with the prerequisite skills and reading skills they are lacking. It is this remediation and the use of digital educational therapy to build and develop those neural pathways in the brain that is the focus of this invention.

Because of the diverse nature of dyslexia, it is virtually impossible for educational systems both public and private to adequately identify and correct or remediate this condition. Therefore, it could be said that dyslexia is more of a teaching disability than a learning disability meaning that all dyslexics can learn to read, where they do struggle however, is in learning to read in a system designed for non dyslexics. The reason for this disconnection is that by virtue of there neuropsychological and neurobiological profiles they lack certain cognitive, phonological, encoding, decoding and comprehension prerequisite skill that must be in place before someone can learn how to read fluently.

In the field of education, there are public and private school systems that provide educational services to the public. As directed by the public and by their nature, these systems must make assumptions about their students in the area of prerequisite reading skills. These prerequisite skills are skills that must be in place before an individual can even begin to successfully build reading skills. To implement a curriculum to a general population school systems must assume that all children already possess all of the prerequisite cognitive, phonological, encoding, decoding and comprehension attributes that are required in order to learn how to read. In fifteen to eighteen percent of human beings these assumptions are incorrect and lead to the disconnection of the individual from the system and method of learning to read. School systems, again by their nature, cannot change their curriculum to fit individual students, so besides retention the prevailing way of dealing with someone that is dyslexic or disconnected from the reading system and method (unable to learn how to read) is to accommodate the condition by reading data to them, technology such as audio books, allowing them extra time to complete assignments and tests or moving them through the system without the receipt of a diploma. The result of these accommodations is that a high percentage of individuals who lack prerequisite skills become functionally illiterate adults. There are approximately forty to forty four million illiterate adults in the United States who cannot read above a fourth grade level and could be classified as dyslexic.

It is this illiteracy and illiteracy cycle in both adults and children that the method and system herein described is designed to address.

Teachers and administrators within a school system are trained to implement a specific curriculum and as such have no training in the psychology, psychometrics, educational therapy, video game design or the diagnosis and treatment of dyslexia. As such, teachers and administrators although knowledgeable in their art of teaching do not possess knowledge in the arts of psychology, diagnostics, educational therapy or video game design and as such could not be expected to envision digital educational therapy as described herein as obvious.

Neurologists, Psychiatrists, Psychologists or a Psychometrician within the scope of their practices may on occasion diagnose dyslexia as characterized by an inability to learn how to read and on very rare occasions uncover the phonological and or cognitive causes of the condition. These individuals do not however treat the condition itself or its causes and do not possess knowledge in the arts of teaching, education, educational therapy or video game design and as such could not be expected to envision digital educational therapy as described herein as obvious.

Video game designers even those versed in the art of educational video games do not possess knowledge in the arts of teaching, education, educational therapy, neurology, psychology, psychometrics and typically provide digital content to teach a subject such as mathematics or a skill such as memory. These individual would not however as those with knowledge in the art of video game design, find it obvious to seek to or know and understand how to remediate dyslexia and would not as someone with knowledge in the art of video games find it obvious to design, develop and provide a complete self monitoring skill building system and method to accomplish the specific goal of remediating a learning disability such as dyslexia as described herein.

Historically there have been non-digital educational therapy programs and methods to provide an individual with some or all necessary prerequisite cognitive, phonological, encoding, decoding and comprehension skills via individual educational therapy. However, individuals having knowledge in the art of educational therapy would not possess the necessarily knowledge in the art of video game design, system and method engineering and or psychology and diagnostics so as to make the system and method of digital educational therapy in a video game format as described in this application and therefore a digital educational system would not be obvious to them. This is evidenced by the non-existence of such a digital educational therapy program in a video game format as described to address all of the prerequisite cognitive, phonological, encoding, decoding and comprehension skills to build reading fluency and comprehension simultaneously in a self-monitoring, software directed, cost effective manner to a wide audience. This traditional educational therapy is also highly labor intensive, expensive in both time and money and not available in all geographic areas.

The existing path to remediation for a dyslexic would consist of:
a) Someone recognizing the condition
b) A complete diagnosis consisting of the specific causes and effects of the condition
c) A face to face educational therapy program driven by the specifics of the diagnosis.

The inventor seeks to positively improve on this system with the invention herein described as follows.

Because digital educational therapy as proposed makes the opposite assumption made by traditional school systems the need for a complete and detailed diagnosis is eliminated. In the embodiment of this invention, it is assumed that the user possesses weakness and deficits in all of the cognitive, phonological, encoding, decoding and comprehension skills. On the surface, this would appear to be a disadvantage in that if a user does not possess a weakness in a certain area they would be forced to do it anyway. However, users receiving digital educational therapy in areas where they are competent actually find those areas to be enjoyable, reinforce and increase the skills they already possess and view these areas as a benefit of completing areas where they may not be as competent. The minimal time that users spend on tasks that they find easy is viewed as fun and helps to engage the user in the overall system and method. Moving users through all areas of possible cognitive, phonological, encoding, decoding and comprehension weakness in a directed way also has the benefit of ensuring that no areas are omitted or left un-mastered thereby ensuring the maximum benefit to the user.

Digital educational therapy as in the embodiment of this invention is also less expensive than traditional educational therapy. Digital educational therapy being available anywhere a computer and internet connection or other form of transmittal is available and being self monitoring eliminates the need for psychoeducational evaluation and the cost associated with it. Digital educational therapy being available anywhere a computer and internet connection or other form of transmittal is available eliminates the need to have the dyslexic transported to a therapy location saving transportation costs, man hours spent in transit for the dyslexic and or their family. Digital educational therapy being available anywhere a computer and internet connection or other form of transmittal is available eliminates the need for the labor of a therapist, facilities for therapy and the cost associated with them.

The end result of this digital educational therapy is to provide the individual with all of the cognitive, phonological, encoding, decoding and comprehension skills required before an individual can begin to learn how to read and to provide the individual with the ability to use these skills, and to build their relationship to and functionality in building reading skills so as the individual becomes a fluent reader and thus remediate the effects of dyslexia.

Further, no digital educational therapy program addresses all prerequisite and reading areas in a sequenced and cumulative approach that vertically and horizontally links all skills and all skill levels together thereby being self monitoring. Additionally no program has provided such a program employing a computer, hand held device, cell phone or other device, means that is both multi and iso sensory depending on the weakness being addressed and the skill being developed.

The embodiment of this invention is web-based/disk-based digital educational therapy program, or reading education program, providing cognitive, phonological, encoding, decoding and comprehension skills and assessments and training.

The embodiment of this invention includes software consisting of games both multi and iso sensory and two and three dimensional in nature, written in any of Adobe Shockwave Flash (SWF) format, Apple iPhone Operating System (iOS), Microsoft XNA Environment (XNA), Linux based Android operating system, Hyper Text Markup Language (HTML) or other means environment or language as is expedient and appropriate.

The embodiment of this invention includes a user interface consisting of the aforementioned software on a server and accessed by a computer, hand held device, cell phone or other device via a website on the internet or universal serial bus flash drive, optical disk, compact disk or other means serving as the source of delivery of the aforementioned software and entered directly into computer, hand held device, cell phone or other device or means.

The embodiment of this invention uses a computer, hand held device, cell phone or other means and or on-line gaming environment to provide cognitive, phonological, encoding, decoding and comprehension skills, educational therapy and particularly reading based assessment and training. Cognitive, phonological, encoding, decoding and comprehension skills differ from reading skills and must be in place prior to initiating the system and method of learning to read. Reading skills are dependent on these prerequisite cognitive and phonological skills. Reading cannot develop normally and adequately without these cognitive and phonological skills.

The embodiment of this invention uses a computer, hand held device, cell phone or other device game format provides educational therapy to simultaneously, sequentially, and cumulatively entertain and build cognitive, phonological, encoding, decoding and comprehension skills and teaches the user how to utilize those to become a fluent reader. Each game is accessed by a code that is provided upon successful completion of the proceeding game in a specific area. The user is provided with a codebook that can be in an electronic or paper format that allows and assists the user to track and record codes and provides an overview of progress. This aspect of the invention is especially important to the parents of dyslexic children in maintaining an overview of progress. Additionally, skill levels and skill areas are interrelated both vertically and horizontally so that the games for a particular area and at a particular level are completed as a prerequisite to proceeding to the next higher level. The linking of skill levels and skill areas provides for an improved likelihood of developing all required reading skills at the highest levels and ensures that no skills can be overlooked.

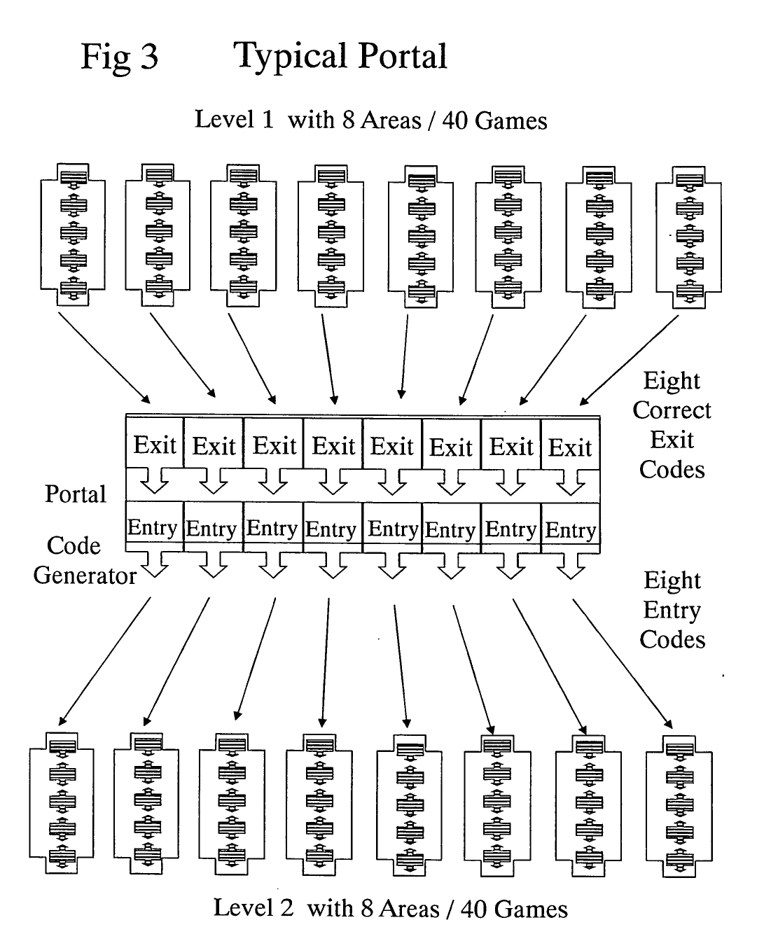

The embodiment presents a reading education program for dyslexics. The opening display screen provides an introduction and instructions for the reading education program, in writing and auditorally, for the associated environment and directs the sure to the “Arcade” as illustrated in FIG. 3. The Arcade screen exhibits instructions and eight characters one each to represent the eight areas of the program, specifically Harmony, Swift, Optic, Tactile, Bamboozle, Recall Array, and Audio as noted in FIG. 3. Each of these characters represent an area in the program dedicated to one or more of the cognitive, phonological, encoding, decoding and comprehension skills being built and or taught. Users are directed and redirected through each game, series of games (areas), series of areas (levels) via portals thus controlling a user's educational therapy program to achieve maximum benefit for the user in minimal time and with minimal expense.

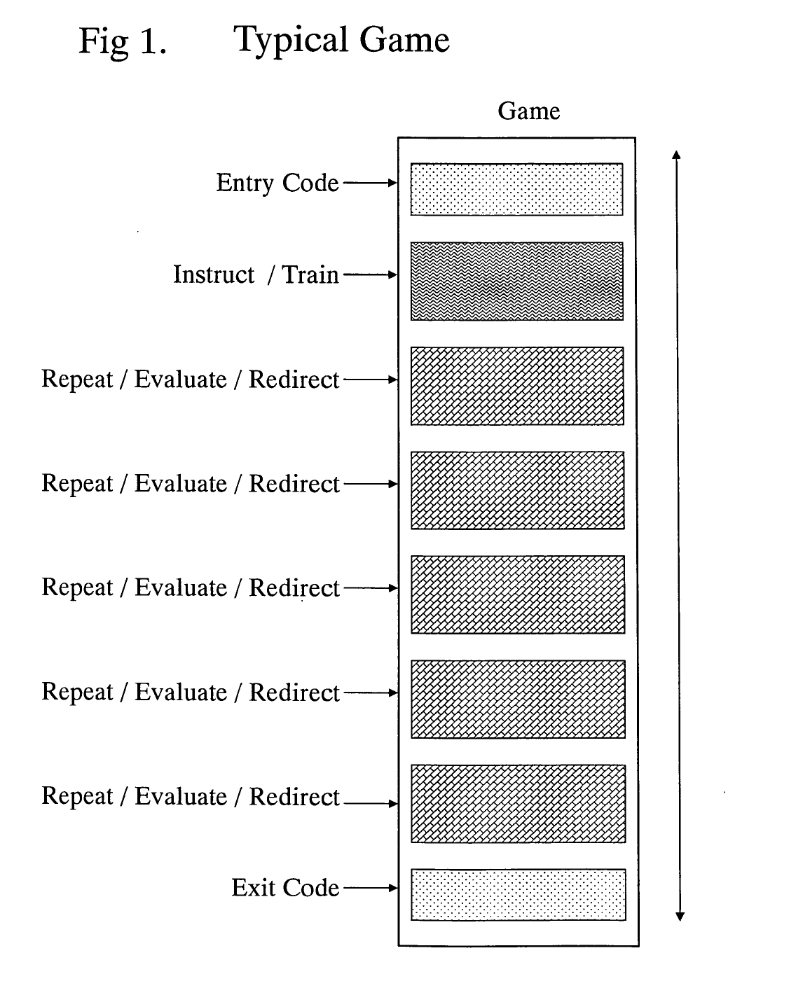

FIG. 1 illustrates an exemplary individual game used for this purpose. FIG. 1 illustrates the use of an entry code to begin playing the game such code to be obtained by successfully completing the proceeding game in that area and level. It should be noted that the first game in the first level of the program does not require the entry of a code thereby granting the user access to the program and process. Once the code is successfully entered the game will proceed to instruct and train the user in the specific skill in question. Upon successful completion of the “instruction and training” section the user is directed to a “repeat, evaluate, redirect” section in which the user is asked to perform an exercise or task demonstrating a grasp of and or a competency in the cognitive, phonological, encoding, decoding and or comprehension skill or principle being taught in the “instruction and training” section. The “repeat, evaluate and redirect” section in each game is designed to constantly re-teach and reinforced instruction and training. Upon an unsuccessful attempt in the “repeat, evaluate, redirect” section the user is redirected to a lower level within a game. Upon a successful attempt in the “repeat, evaluate, redirect” section the user is directed to the next highest section of the game.

The environment of each game is such as to be engaging, entertaining for all age groups and pleasant but not so much so as to distract and deter the user from the purpose of the game itself. The reading education program provides a fun and entertaining environment for building the basic skills required before learning to read can take place and to read once those skills are developed and does so for all age groups. The reading education program provides digital educational therapy to improve accuracy, speed, memory, phonological processing, advanced visual tracking performance, and develop cognitive and phonological skills. The reading education program provides assessment and learning for areas from basic phonics and reversal of letter up to and including advanced memory and fluency. The reading education program does not assume a specific skill in the reader, but rather assumes that skills are or may be lacking and provides for improvement in all skills.

Digital educational therapy provides for both multi-sensory and isolation capabilities. Digital educational therapy is in some instances multi-sensory for providing help to an individual in acquiring information. Digital educational therapy also isolates a sense to provide for the strengthening of that capability. Digital educational therapy is sequential and cumulative in its approach such that one game builds upon another in the same area, areas build on other areas within a level and levels build on other levels to bring about an improvement in reading and processing capabilities.

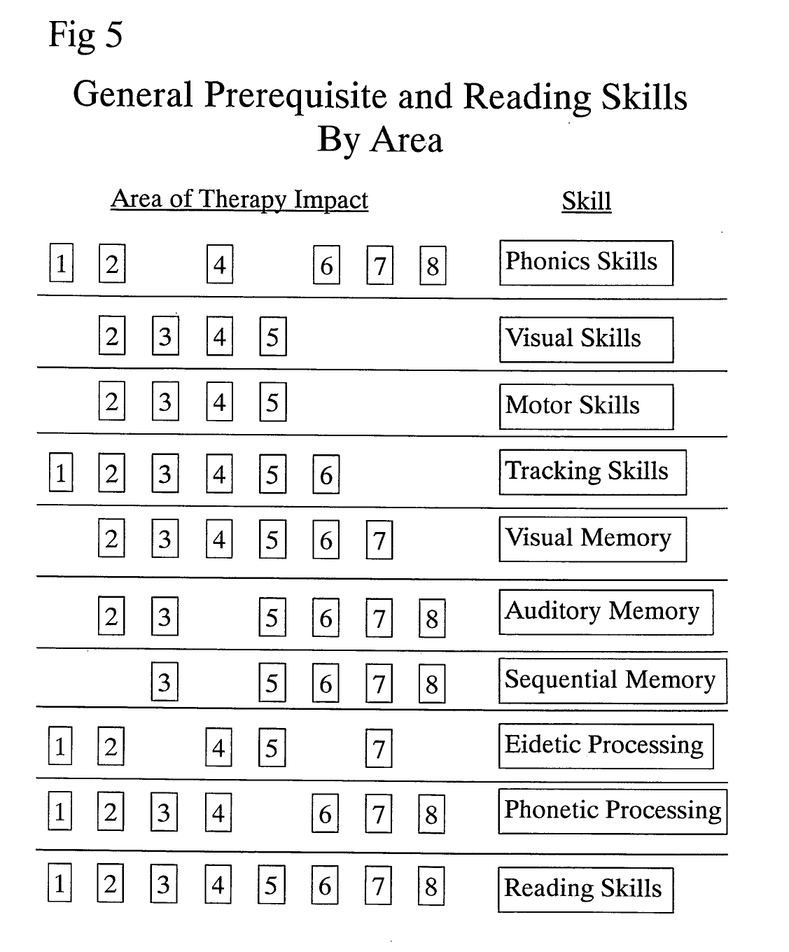

FIG. 5 provides an exemplary illustrating how the interactive characters of the reading education program correspond to linguistic, cognitive, and phonological and comprehension skills. In FIG. 5 also illustrates by name interactive characters named OPTIC, RECALL, TACTILE. ARRAY, AUDIO, BAMBOOZLE, HARMONY and SWIFT and indicates the specific areas where they interact with the user.

The exemplary interactive characters provide interaction with the user in each game environment associated with particular skills and capabilities. Of course, those of skill in the art will appreciate that the character names may be varied and the number of interactive characters may be varied according to the skill sets being evaluated, taught and directed.

In the illustrated embodiment, the interactive character HARMONY is associated with order to assimilate the many skills together in a useful manner and combining them with phonics so that such skills can be used together at the same time and accurate fluent reading can take place.

In the illustrated embodiment, the interactive character SWIFT is associated with speed. Such a skill provides developing and using the assimilated skills quickly and efficiently for processing, comprehending, remembering and using information.

In the illustrated embodiment, the interactive character OPTIC is associated with utilizing the eyes to move and track properly from left to right and in a straight line, to gather information and to have that information perceived accurately and efficiently in the brain. Such a skill improves the ease, accuracy and speed for processing visual information.

In the illustrated embodiment, the interactive character TACTILE is associated with objects, space, and movement to provide mental power to effectively manipulate objects and information on screen which improves the ability to manipulate objects visually and reproduce shapes, represent shapes dimensionality and the relationships between objects and to do so in the real world. Such a skill provides the ability to use one's mind and hands to duplicate what is seen.

In the illustrated embodiment, the interactive character BAMBOOZLE is associated with eidetic words that deviate from the more common rules, such as when spelling doesn't make sense for Example “could” is an eidetic word that when spelled phonetically should be “cud”. Eidetic words are critical in that they give much of the written English language its contextual meaning. Such a skill provides for the reading, spelling and use of irregular words as well as improving sequential memory. The BAMBOOZLE character provides trickery to test the skills developed and provides for improved reading, memory and understanding.

In the illustrated embodiment, the interactive character RECALL is associated with accurate visual perception, overall and sequential visual and auditory memory to develop skills to capture, keep or remember what the user sees and hears in their mind. Such a skill improves the ability to capture and retain information for when it is needed.

In the illustrated embodiment, the interactive character ARRAY is associated with keeping what is seen and heard in the correct sequence. This provides the skills and practice for knowing the order of items and how to retain that order. Such a skill improves the capability for following directions so that spelling becomes a simple system and method, system and method sequential data such as timelines and mathematics problems.

In the illustrated embodiment, the interactive character AUDIO is associated with identifying and remembering the sounds and words we read and hear. Such a skill provides for reading fluently and automatically as well as automatically breaking words down into smaller parts and then using those parts to build and understand both known and unknown words quickly and easily.

FIG. 3 illustrates an exemplary portal configuration for the direction of the user and transition between skill levels. The exemplary portal configuration illustrates that an exit code is provided upon successful completion of a game typically the last game within a particular area. Once all games at the corresponding skill level are successfully completed, the last codes from each area, eight codes in total are entered into the corresponding Portal. The exact entry of eight correct codes in a portal will by means of the program and software generate eight corresponding codes for entry into the first games in each area of the next higher level. Further, the entry of the exact entry of eight correct codes in a portal will provide the user with a number of tokens and a higher ranking thereby helping to incentivizing the digital educational process. In this way, the skill levels and skill areas are interrelated so that the all games for a particular area and at a particular level are completed as a prerequisite to proceeding to the next higher level thus controlling and dictating the users movement within the program to ensure the greatest likelihood of success and maintain the integrity of the scope and sequence of the educational therapy.

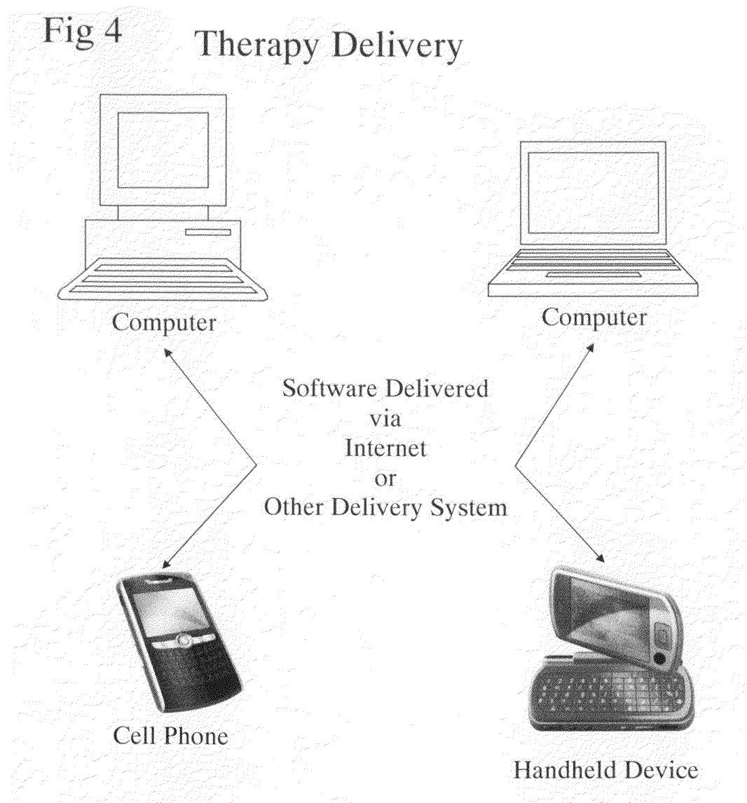

FIG. 4 Illustrates two embodiments of the implementation, and distribution of the digital educational therapy program to the end user. In the first embodiment software is distributed to a user directly from a web server through a website on the internet to the users computer, hand held device, cell phone or other device as may become appropriated and convenient. In the second embodiment the software is distributed to the user directly for use on their computer, hand held device, cell phone or other device from a universal serial bus device, disk or other device as is appropriate. These delivery systems eliminated the need for the dyslexic to leave their existing location, travel to an educational therapist for educational therapy and return. Further, this eliminates the need for the parents of dyslexic children to travel with their children and or other siblings to an educational therapist for educational therapy. The net result of the digital educational program and system as invented is a significant savings in time, resources and the financial investment needed to remediate the effects of dyslexia. These savings have the effect of making digital educational therapy available to a wider number of dyslexics then currently have services available to them and furnish a general increase in literacy. By eliminating the dyslexics current dependence on having an educational therapist located within a reasonable geographic distance digital educational therapy as invented will make educational therapy available to a wider number of dyslexics then currently have services available. By being available at any time to the dyslexic the digital educational program as described provides therapy to the dyslexic at a time and place that they choose thereby increasing the likelihood of completing this therapy program in comparison to a traditional therapy program. The nature of digital educational therapy being in a video game format also encourages a lighter more fun like interaction during educational therapy increasing the likelihood that a program will be completed successfully. Digital educational therapy being administered and controlled by software in a game format through a computer, hand held device, cell phone or other device and the nonjudgmental nature of those devices makes the interaction of the user non judgmental, less stressful and embarrassing than face to face educational therapy. This is especially true of older dyslexics who have significant amounts of embarrassment because of their condition and may have developed a distaste of education in general.

FIG. 5 is a table mapping prerequisite skills, reading skills, linguistic and cognitive and phonological skills to a specific area and character. As noted above in FIG. 3, the skill levels and skill areas are interrelated so that the user is directed and controlled so that only when games are completed at a particular level is access granted to the next higher level. The exemplary table illustrates a mapping of various reading skills and problem areas to the various linguistic and cognitive and phonological areas and their characters. The various games within the reading education program provide for assessment of the reading skills and problem areas throughout play and the direction of the user based on their performance in those games and areas.

Although each game area and each game may addresses a number of different skills and data types certain characteristics are for the most part universal to all games. These substantially universal characteristics include (1) skill exposure and or data acquisition system and method, (2) skill development and or data retention system and method, (3) repetition of skill development or data retention system and method, (4) skill development and or data acquisition and retention testing, (5) positive reinforcement of adequate skill development and or data acquisition and retention (i.e., winning the game, applause, points gained, advancing to the next level), (6) negative reinforcement of inadequate skill development and/or data acquisition (i.e., losing the game, negative sounds, lost points), and (7) repetition of the system and method until a successful result is achieved.

In order to be fluent at reading, a person must possess and be proficient in eight linguistic and cognitive and phonological areas: (1) eidetic processing, (2) visual, auditory, sequential, immediate, short term and long term memory, (3) sequencing/tracking, (4) visual perception, (5) visual motor integration, (6) phonological processing, (7) phonics, and (8) fluency. These linguistic and cognitive and phonological areas encompass a wide variety of skills and skill levels.

Additionally, the linguistic and cognitive and phonological areas interact with each other in fractions of seconds when a person is reading such that a weakness in any one area influences performance in the other areas and reading as a whole.

As illustrated in FIG. 5 Area 1 corresponds to harmony, for example assimilating the many skills together in a useful manner so that such skills can be used together at the same time. Exemplary skills and problem areas include phonological awareness, sound matching, elision, blending words, phonological memory, nonword repetition, memory for digits, tracking, eidetic processing, phonetic processing, reading rate, reading accuracy, reading fluency, reading comprehension, oral reading quotient, word reading, and pseudoword decoding, among others.

As illustrated in FIG. 5 Area 2 corresponds to the swift area, or speed, for example developing and using the assimilated skills quickly and efficiently for processing and using information. Exemplary skills and problem areas include phonological awareness, sound matching, elision, blending words, phonological memory, nonword repetition, memory for digits, tracking, vergence, visual perception, eidetic processing, phonetic processing, reading rate, reading accuracy, reading fluency, reading comprehension, and oral reading quotient, among others.

As illustrated in FIG. 5 Area 3 corresponds to the optic area, for example utilizing the eyes to gather information accurately and efficiently to improve the processing of visual information. Exemplary skills and problem areas include tracking, vergence, visual perception, reading rate, reading accuracy, reading comprehension, oral reading quotient, word reading, and pseudoword decoding, among others.

As illustrated in FIG. 5 Area 4 corresponds to the tactile area and is associated with objects, space, and movement for effectively manipulating objects and information on screen and to use one's mind and hands to duplicate what is seen. Exemplary skills and problem areas include tracking, vergence, visual motor integration, eidetic processing, reading rate, reading accuracy, oral reading quotient, spelling, and word reading, among others.

As illustrated in FIG. 5. Area 5 corresponds to the bamboozle area and is associated words that deviate from the most common rules, such as when spelling doesn't make sense for example, as in the spelling and use of irregular words. Exemplary skills and problem areas include tracking, vergence, visual motor integration, visual memory (overall), visual memory (immediate), visual memory (short term), visual memory (long term), auditory memory (overall), auditory memory (immediate), auditory memory (short term), auditory memory (long term), eidetic processing, oral reading quotient, and spelling, among others.

As illustrated in FIG. 5 Area 6 corresponds to the recall area associated with visual and auditory memory for the development of skills to keep or remember what the user sees and hears in their mind, to improve The ability to retain information for when it is needed. Exemplary skills and problem areas include tracking, visual perception, visual memory (overall), visual memory (immediate), auditory memory (overall), auditory memory (immediate), reading rate, reading accuracy, reading fluency, reading comprehension, and oral reading quotient, among others.

As illustrated in FIG. 5 Area 7 corresponds to the array area and is associated with keeping what is seen and heard in the correct sequence for knowing the order of items and how to retain that order. Exemplary skills and problem areas include visual memory (overall), visual memory (immediate), visual memory (short term), visual memory (long term), auditory memory (overall), auditory memory (immediate), auditory memory (short term), auditory memory (long term), reading comprehension, oral reading quotient, and spelling, among others.

As illustrated in FIG. 5 Area 8 corresponds to the audio area and is associated with identifying and remembering the sounds and words we read and hear for breaking language down into smaller parts and then using those parts to build and understand new words. Exemplary skills and problem areas include phonological awareness, sound matching, elision, blending words, phonological memory, nonword repetition, memory for digits, phonetic processing, reading rate, reading accuracy, reading fluency, oral reading quotient, word reading, and pseudoword decoding, among others.

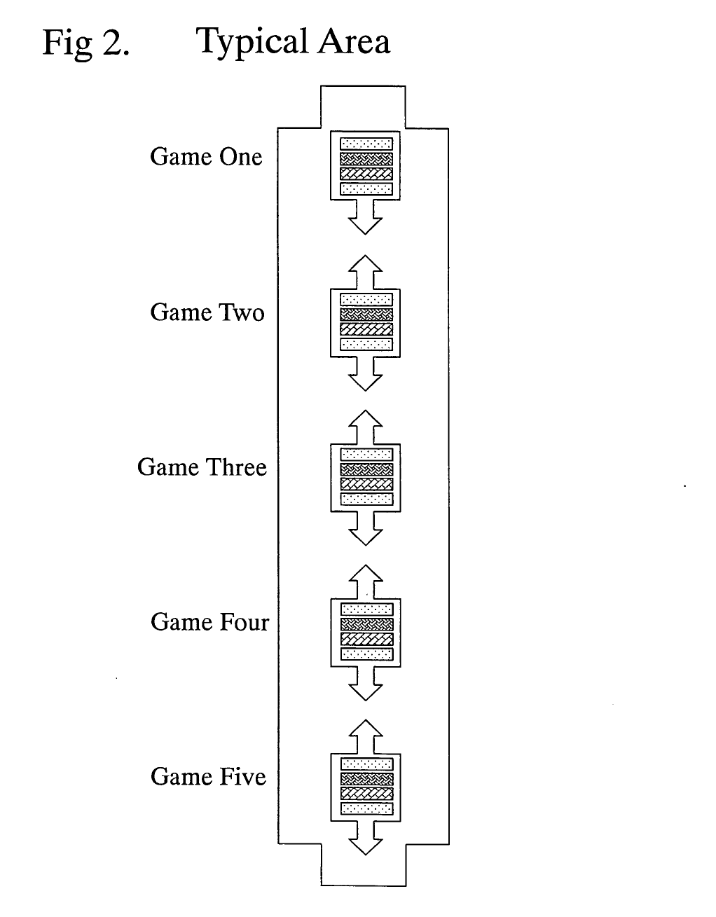

As illustrated in FIG. 3 there is a relationship of games to game areas, game areas to skill levels, and skill levels to subsequent skill levels as controlled by portals. As shown in the exemplary illustration of FIG. 1 and FIG. 2, illustrating individual games within any area are password coded so that they are played in sequence. For example, in area 1 (Harmony) the first game (game 1) must be completed before proceeding to game 2, and so forth. Upon completion of game 5 within a particular area, a password or code is provided to indicate completion. The correct exit password for all eight areas must be entered in a portal the portal then generates entry codes to the first game in each of the eight corresponding areas granting the user access to this new level. In other words, the user must complete each game in each area and complete all areas within a certain level before proceeding to the next level. This process, direction and control is continued and repeated throughout the digital educational therapy process.

In one embodiment as represented in FIG. 3, access to the next level is provided via a portal where the passwords generated by the fifth and last game in each area are entered. Once all passwords are correctly entered access is provided by the program to the next higher level in all eight areas within the digital educational therapy and reading program. The portal as represented also provides the user with incentives including increased tokens, rank or other incentives as is practical. The process of going through a portal does not preclude the user from accessing any earlier games or levels for the purpose of review.

In the illustrated embodiment of FIG. 3, a total of two levels and one portal are provided. The number of levels and portals may vary according to the number of games within a particular embodiment of the digital education therapy and reading program. For example at this time and in practice, twenty-one levels and twenty portals are operational.

The design, use of and control of a users experience in areas is critical to the success and efficiency of directed educational therapy for dyslexics. To illustrate this point and to give the examiner a further understanding of each area a general description of a typical game in each area is undertaken. This is by no means a limitation on the type, modality scope and sequence of games, games within and area and it should be noted that games in a certain area by the nature of their construction might teach more than one prerequisite skill.

Area 1 (FIG. 3) Phonics Characterized by HARMONY—Phonics is the ability to acquire, remember and use syllables to decode (read) and encode (spell) phonetically correct words. This skill allows and individual to apply linguistic logic to the reading system and method so that they can attack unknown phonetically regular words while reading and gain the meaning and pronunciation of those words.

An illustration of a digital educational therapy game illustrating Area 1 the area of phonics activities as characterized by HARMONY consists of the entry of a correct entry code followed by an introduction and an initial screen that presents the opportunity for learning short vowel sounds. The screen includes the interactive character “Harmony”, five vowels marked as short vowels, and instructions for proceeding as well as practice in clicking on the five short vowel objects to hear and repeat their correct individual specific sounds. When the user is ready to proceed the “Next” button is selected. The first game screen includes the HARMONY character, a group of hearts, a score indicator, a play button, and a question mark in the top section of the screen. The lower screen includes each of the marked short vowels. When the user selects the “Play” button, a short vowel sound is heard. Upon hearing a short vowel sound, the user repeats that correct short vowel sound, drags the corresponding short vowel object to the question mark, and the score is increased for a correct answer a multisensory approach in this area (sight, touch, sound) is highly beneficial. If the user drags an incorrect short vowel, the heart count is decreased and the user is given the opportunity to try again with the incorrect choice now missing from the choices. Successful completion of the game provides the opportunity to proceed to the next game. Exceeding the maximum number of incorrect responses redirects the user back to the instructional area to review the short vowel sounds and proceed accordingly.

Area 2 (FIG. 3) Fluency Characterized by SWIFT—Fluency refers to the speed, accuracy and comprehension with which an individual can read. Without adequate speed, accuracy and comprehension the purpose of reading is at the least undermined and usually lost. In an educational therapy setting and in this digital educational therapy the goal is to make fluency “automatic” so that the individual reads “without thinking”. Anything less and the mechanics of the reading system and method will lead the individual's speed, accuracy, comprehension or possibly all to suffer.

An illustration of a digital educational therapy game in Area 2 the area of fluency as characterized by SWIFT consists of the correct entry of an entry code, an introduction followed by an opening screen where the user is presented with an untimed warm up screen displaying a group of words. After each word is pronounced by the game, the user selects that specific word from a screen containing a number of words and the word is removed from the screen. Once all the words are removed from the screen, the user may proceed to the next screen for reading.

Following the warm up the user is presented with a screen in which they must perform and action such as pressing the space bar in order for the screen to become active. Once active the reading screen presents a group of sentences, a group of hearts, and a score indicator and a prompt to read all sentences aloud. These sentences can be repetitive or none repetitive as dictated by a specific area or level of the program. With a brief pause a cursor moves from left to right highlighting the first sentence word by word. The user is encouraged to read each sentence aloud following the cursor that moves from left to right as a specified speed. In the illustrated embodiment, the sentences are repeated multiple times. Moving down the screen the cursor tracks each sentence and the speed of the cursor increases with each of the three sentences. With each, the reader is encouraged to follow along with the cursor and read each sentence aloud and correctly. When a new sentence is shown, the speed of the curser reverts to a lower level and increases as in the example already given. Once the cursor completes moving across each and every sentence it disappears and the user is presented with a multiple choice question about the content of the reading. A correct answer increases the score and presents the opportunity for more reading. An incorrect answer prompts a redirection.

Area 3 (FIG. 3) Visual Perception Characterized by OPTIC—The eyes are used to gather information accurately when reading and performing other activities. Visual Perception is the ability to quickly perceive visual information accurately. This is not to be confused with eyesight but more specifically is how information that is captured by the eyes registers in the brain. A deficit in this area effects the ability to accurately process information that is presented through the visual modality and exhibits itself in symptoms such as reversals and rotations such as substituting “b” for “d” and vise versa and the perception that written material is moving on a page.

An illustration of a digital educational therapy game in Area 3 the area of visual perception as characterized by OPTIC consists of the correct entry of an entry code, an introduction followed by an instruction screen which contains a play button. After instructions and procedures such as press the “up arrow” for true and the “down arrow” for false on your keyboard are comprehended and when the user presses the play button the user is presented visually with a letter such as “b” and an oral presentation of a letter. This oral presentation of a letter my match the visual presentation shown on the screen or it may not. It is the users task to determine if the visual presentation and or oral presentation match or not and to do so by pressing the up arrow on a keyboard for a matching answer and the down arrow on a keyboard for a non matching and must do so in a specific period of time which may decrease as competency increases. A correct response triggers increases the users points whereas an incorrect response decreases the users heart count. The loss of all hearts (three) and redirects the user.

Area 4 (FIG. 3) Characterized by TACTILE—Visual motor integration is the ability to accurately perceive and reproduce visual information via finger-hand movements. It affects the ability to write, to copy work from other sources, to line up math problems, and to perform many other reading and writing tasks.

An illustration of a digital educational therapy game in Area 4 the area of visual motor integration as characterized by TACTILE consists of the correct entry of an entry code, an introduction followed by an instruction screen that contains a play button. In the illustrated example, a turntable is present below an outline of a shape or group of shapes, along with a group of hearts, and a score counter. A group of filled-in or colored shapes are located on either side of the turntable. The user can use their mouse to select and drag and drop a shapes. Upon selecting a shape, the user moves the shape over the turntable and the turntable rotates the image. Once the image is oriented correctly to fit within one of the shape outlines above, the user moves the shape off the turntable at which point its rotation stops and it can then be moved into the corresponding shape outline with the mouse. Correct orientation and placement of a shape or shapes triggers a positive “click” of the shape to reinforce the learned behavior and provides for an increase in the score. Incorrect orientation or placement of a shape or shapes does not trigger a game response. The successful placement of shapes on all of the outlines presented in their correct orientation in the specified time will provide the opportunity to progress to the next screen which will continue the skill building process using a different shape. A failure to accomplish a sufficient number of successful attempts will result in a redirection. The time allowed to complete this task, the complexity and number of the shape being over laid and the visual appearance of the shape and or shapes can be and is varied between games and levels.

Area 5 (FIG. 3) Characterized by BAMBOOZLE—Eidetic language and processing refers to the “irregular” side of the English language and is characterized by words that are not spelled the way that they sound (could) (laugh). If these words were spelled accurately according to phonological rules and logic they would be “cud” and “laf”. Many irregular words are used to provide contextual meaning in the English language and are critical to accurate reading and comprehension. A thorough working knowledge of irregular words is critically an important part of learning to encode and decode correctly and fluently.

An illustration of a digital educational therapy game in Area 5 the area of eidetic processing as characterized by BAMBOOZLE consists of the correct entry of an entry code, an introduction followed by an instruction screen in which the user is presented visually with ten eidetic words (words that are not spelled as they sound), their correct spellings, their usage in a sentence are shown. The user is also instructed and allowed to click on each of the ten eidetic words and hear the correct pronunciation of the word its correct spellings and its usage in a sentence auditorally. The user is encouraged to repeat the pronunciation, spelling and usage of all ten of the eidetic words presented as well as the sounds of letters they are using to spell words and to do so each and every time they are presented with this information throughout the game. The user is allowed and encouraged to review these words using the instruction screen for as long as they desire and until they feel comfortable with the spelling of each of the ten words. This instruction screen also contains a play button. At the users discretion they may select the play button to proceed to the next screen.

After selection of the play button, the user is presented with a screen for the tactile spelling of one of the ten words previously listed. There will be ten of these screens in this example one for each of the words presented. The first screen includes the letters from the first word in a scrambled order on the lower portion of the screen. Upon pressing a replay button user hears the pronunciation of the word along with a sentence using the word. After hearing the pronunciation and sentence for the word, the user is presented with a box numbered 1 that appears on screen indicating the first letter in the word. The user then drags a letter from the scrambled letters in the lower portion of the screen that they believe to be the correct letter to collide the letter with the box numbered 1 If the user is correct the letter replaces the box. This multi-sensory approach to accurate encoding is beneficial in building the required neural pathways required for efficient and accurate eidetic processing. Any attempt by a user to place a letter incorrectly will not be allowed and the user will lose a heart and immediately be redirected. This immediate redirection does not allow the user to spell a word incorrectly that would have the negative effect of reinforcing an incorrect spelling that is a common flaw in spelling programs. If the letter is applied correctly, a new box appears with the number “2”. The user drags what they believe to be the next correct letter in the word so as to collide with the box numbered 2 and as in the example above if the letter is correct the letter replaces the box and incorrect the user is redirected. This process continues until all letters are placed correctly in order to spell the word. Upon successful completion of each word a score bar provides an indicator of progress and a “Next” button appears for initiating the spelling of the next word and the process is repeated with the next word. Upon the successful completion of ten words the user is then directed to spell the ten words using a keyboard being prompted with an auditory pronunciation of the word and its usage in a sentence and a second auditory prompt of the word. Less than a ninety percent success rate will prompt an automatic redirection. At the end of the first four games in a level and as a fifth game in a level the user is then directed to enter the last forty words learned using the keyboard after being prompted auditorally by the pronunciation of the word, its correct usage in a sentence and a second auditory prompt of the word. Again, less that a ninety percent success rate will prompt an automatic redirection.

Area 6 (FIG. 3) Characterized by RECALL—Sequencing, remembering and tracking activities provide for acquiring and maintaining what is seen and heard in the correct sequence order. Sequencing and tracking is the system and method whereby an individual is able to move their vision across written data in the correct direction from left to right with adequate speed and progress from line to line without deviating up or down, skipping or reverting to the same line or a higher one. A deficit in this area could be characterized as “losing ones place” or that the “letters and words are moving”.

An illustration of a digital educational therapy game in Area 6 the area of sequential memory processing and tracking as characterized by RECALL consists of the correct entry of an entry code, an introduction followed by an instruction screen in which the user is presented detailed instruction and practice and containing a play button. After sufficient practice and orientation the user at their discretion clicks on the play button. In one illustrated embodiment is shown a character walking along a path. As the character walks, letters of the alphabet in sequence appear above the character's head. After the two letters appear the character stops and a third location remains empty. In response to the empty location, the user enters the next appropriate letter in the sequence via a keyboard within a specific amount of time. If the user does not enter a letter or does not do so in a timely manner, the characters movement will reinitiate and if he exists the screen to the right before the task is correctly performed the user will be redirected. Upon the user's entry of the letter “c” the characters turns again and begins to walk and exits the screen to the right prompting a new screen and a new sequence presented in the same fashion.

Of course, many sequences are useful for evaluating the user's ability to determine the next appropriate letter or word. For example, the progression could omit either the first or second or third letter in a sequence. In another illustration, the missing letter is the middle letter rather than the last letter on the right. In such an instance, the letters appear before and after the location of the interactive game character. The completion of a sufficient number of missing letters will provide the opportunity to proceed to the next game. This area is expanded over time to include a variety of information such as words, sentences, pictures and other data to expand sequencing, recall, tracking and other cognitive areas. In another illustration, and presented in a different fashion the progression could consist of the entire alphabet where the user would be required to perform and action such as pressing the space bar on each letter of the alphabet in sequence when highlighted by a cursor as the cursor moves across a page filled with random letter from left to right and down line by line.

Area 7 (FIG. 3) characterized by ARRAY—Memory is the cognitive process used by a person to acquire and retain information. The information can be auditory, visual, tactile and or multi-sensory depending on how it is presented to the individual. In order to be a fluent reader, an individual must possess adequate immediate, short term and long term memory in the visual and auditory modalities, be able to retain a sufficient total amounts of data in the visual and auditory modalities and keep that data in its correct sequential order.

An illustration of a digital educational therapy game in Area 7 the area of memory and sequential memory as characterized by ARRAY consists of the correct entry of an entry code, an introduction followed by an instruction screen in which the user is presented a play button that can be clicked at the users discretion. Upon clicking the play button the user is presented a game screen shortly thereafter the user is presented with a group of numbers, letters or mixed numbers and letters for a specific amount of time. This data can be presented one letter or number at a time in a timed sequence or as a block of data. The information is presented in only one modality and only one time. This iso sensory approach is critical to improving any weakness a user may exhibit in that area. After a specific amount of time the user is asked to enter the data they saw or heard using a keyboard, as the user presses a key on a keyboard they are not shown the letter or number they are typing as such information would defeat the iso sensory nature of the exercise. They are however rewarded and indicated that they have used a correct letter or number in the correct sequence beginning with the first and progressing to the second etc. A complete correct answer allows the user to play a video game for a short time that is designed as a distracter but which does reward the user with points. At the end of the distracter the user is again prompted to enter the data that they saw or head in its correct order. This system and method is repeated so as the user has to enter the data three times. This sequence is repeated several times with new data in each instance. Incorrect answers are immediately and automatically redirected whereas correct answers in all areas will allow the user to advance.

Area 8 (FIG. 3) Characterized by AUDIO—Phonological processing including phonological awareness and phonological memory is critical to reading. English is a phonics based language comprised of symbol to sound relationships that form the basis of linguistic logic. An awareness of phonics, the ability to hear, manipulate and remember sounds and syllables, is central to breaking down language into smaller parts that are used to build and understand new or different words as well as general phonics skills that are critical to fluent reading of English or any phonetic language. Phonological system and processing skills are the basic building blocks of phonics and encompass a person's ability to actually auditorally process the sound of syllables, separate and rearrange syllables, and to remember those syllables and their corresponding sounds. Phonological processing is a more basic set of skills that must be in place before an individual can learn phonics. As such phonological processing should not be confused with the overall use and teaching of phonics which is the teaching of someone who has phonological skills to read using phonics. Both phonological processing and phonics are the subject of this invention and more specifically this area of the invention.

An illustration of a digital educational therapy game in Area 8 the area of phonics and phonological processing as characterized by AUDIO consists of the correct entry of an entry code, an introduction followed by an instruction screen in which the user is presented a play button which can be clicked at the users discretion at which time the user is directed to a game screen. Once active in the game screen the user is presented with the Audio character, a play button, a check button, an add button and a subtract button a group of hearts, and a score indicator and a horizontal line that includes multiple numbered circles. In this illustrated embodiment upon clicking the play button the user is presented auditorally with a word, the user may hear this word as many times as they feel necessary. It is then the users task to select how many syllables are contained in the target word they heard by clicking on the add button and or the subtract button which highlights the numbered circles until they have arrived at what they consider to be the correct number of syllables as indicated by a highlighted numbered circles. The user may use the add and subtract buttons as many times as they wish to change the syllable count at any time before entering his or her answer with the check button. Once a number of syllables is decided upon the user then clicks on the check button to determine if they are correct. A successful entry of the syllable count increases the score. An incorrect entry of the syllable count causes the loss of a heart. The loss of all hearts (three) causes an immediate redirection.

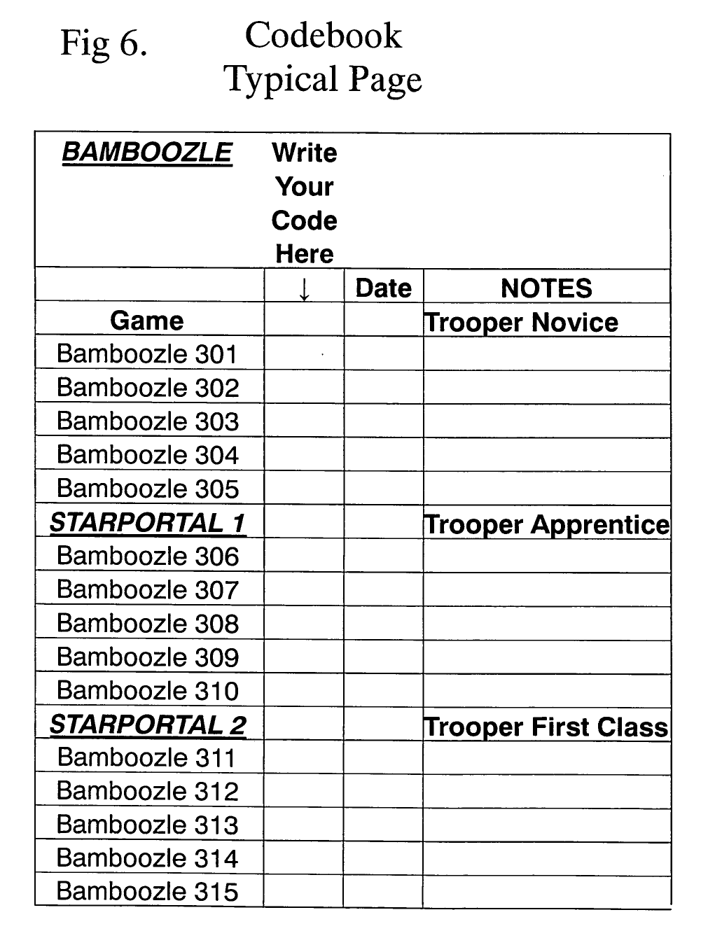

The embodiment of this invention also uses a codebook as illustrated in FIG. 6 to allow users to track progress and to incentivize the digital educational therapy process. This codebook can be provided in an electronic format, paper format or other as is practical. This codebook also tracks and incentivized the digital educational process by reinforcing that the user is reaching new higher ranks, earning additional tokens each time they pass through a portal and acts as a visual cue to increase self esteem and progress awareness.

From the foregoing description, it will be recognized by those skilled in the art that a digital educational therapy program, and reading education program, for the assessment and training of cognitive, phonological, encoding, decoding and comprehension skills has been provided. Further, that a digital educational therapy program to identify on an ongoing basis the cognitive, phonological, encoding, decoding and comprehension strengths and weaknesses of an individual and direct that individuals digital educational therapy program in such a way as to maximize the chances of overall success in the area of reading has been provided. While the present invention has been illustrated by description of several embodiments and while the illustrative embodiments have been described in considerable detail, it is not the intention of the applicant to restrict or in any way limit the scope of the appended claims and or games to such detail. Additional advantages and modifications will readily appear to those skilled in the art. The invention in its broader aspects is therefore not limited to the specific details, representative apparatus and methods, and illustrative examples shown and described. Accordingly, departures may be made from such details without departing from the spirit or scope of applicant's general inventive concept.

While the preferred embodiment of this invention has been described in the Detailed Description, the scope of the invention is defined in the following claims.

What is claimed is:

1. A digital educational therapy system to build neural pathways in the brain thereby providing the user with all prerequisite reading skills and general reading skills required for reading and further providing the user with the necessary knowledge and practice so as to employ those skills to become a fluent reader said system comprising:
an automated software controlled digital educational therapy program addressing all the cognitive, phonological, encoding, decoding and comprehension weaknesses exhibited by dyslexics and non-readers;
a digital computer based educational therapy program in 2D or 3D addressing all the said weaknesses exhibited by dyslexics and non readers in a system employing game software the content of which can be formatted as Adobe Shockwave Flash (SWF) format, Apple iPhone Operating System (iOS), Microsoft XNA Environment (XNA), Linux based Android operating system, Hyper Text Markup Language (HTML) or other means of formatting;
an digital educational therapy program addressing all the said weaknesses exhibited by dyslexics and non readers utilizing a web, wireless, universal serial bus, optical disk or other electronic means of delivery;
a digital educational therapy system addressing all the said weaknesses exhibited by dyslexics and non readers and designed to run on a computer, hand held device, tablet, cell phone or other electronic means;
a digital educational therapy program employing 2D or 3D video games as a means of therapy that are either multisensory or isosensory addressing all the said weaknesses exhibited by dyslexics and non-readers comprising;
a) exposing the user to video games designed to build all the cognitive, phonological, encoding, decoding and comprehension skill required by dyslexics and non readers;
b) collecting user input from the user concerning their ability to perform certain cognitive, phonological, encoding, decoding and comprehension skills acts as presented in a game format;
c) automatically redirecting a users on an individual basis in accordance with their performance and or ability in each cognitive, phonological, encoding, decoding and comprehension game, game area and level thereby causing improvement in all areas;
d) automatically controlling which games, areas and level of the digital educational therapy process and the cognitive, phonological, encoding, decoding and comprehension skills the user can access, learn and use;
e) to have a number of different cognitive, phonological, encoding, decoding and comprehension games in a specific area interrelated vertically with the proceeding and following games and areas;
f) to have a number of different cognitive, phonological, encoding, decoding and comprehension games in a specific area interrelated horizontally with games in other areas and vertically with areas above and below;
g) to have a number of different cognitive, phonological, encoding, decoding and comprehension areas in a level interrelated horizontally with areas in other areas and vertically with areas above and below;
h) to have a number of different cognitive, phonological, encoding, decoding and comprehension games in a specific level interrelated vertically with games in other levels;
i) to redirect a user vertically and horizontally in accordance with their performance ability in one game, area or level to corresponding cognitive, phonological, encoding, decoding and comprehension games in other areas and levels thereby causing and ensuring improvement in all areas of weakness;
j) providing a codebook or other means for the user to track their progress both overall and in specific areas and to incentivize the digital educational process;

2. The method of claim 1, wherein the area of educational therapy and skill being trained, assessed and directed consisting essentially of visual perception interacting with visual motor integration, visual and auditory sequential/immediate/short term/long term memory, phonological awareness, phonological memory, eidetic processing, tracking, vergence, phonics, reading rate, reading accuracy, reading comprehension, phonetic spelling, eidetic spelling, word reading.

3. The method of claim 1, wherein the area of educational therapy and skill being trained, assessed and directed consisting essentially of visual motor integration interacting with visual perception, visual and auditory/sequential/immediate/short term/long term memory, phonological awareness, phonological memory, eidetic processing, tracking, vergence, phonics, reading rate, reading accuracy, reading comprehension, phonetic spelling, eidetic spelling, word reading.

4. The method of claim 1, wherein the area of educational therapy and skill being trained, assessed and directed consisting essentially of visual and auditory/sequential/immediate/short term/long term memory, interacting with visual perception, visual motor integration, phonological awareness, phonological memory, eidetic processing, tracking, vergence, phonics, reading rate, reading accuracy, reading comprehension, phonetic spelling, eidetic spelling, word reading.

5. The method of claim 1, wherein the area of educational therapy and skill being trained, assessed and directed consisting essentially of phonological awareness interacting with visual perception, visual motor integration, visual and auditory/sequential/immediate/short term/long term memory, phonological memory, eidetic processing, tracking, vergence, phonics, reading rate, reading accuracy, reading comprehension, phonetic spelling, eidetic spelling, word reading.

6. The method of claim 1, wherein the area of educational therapy and skill being trained, assessed and directed consisting essentially of phonological memory interacting with visual perception, visual motor integration, visual and auditory/sequential/immediate/short term/long term memory, phonological awareness, eidetic processing, tracking, vergence, phonics, reading rate, reading accuracy, reading comprehension, phonetic spelling, eidetic spelling, word reading.

7. The method of claim 1, wherein the area of educational therapy and skill being trained, assessed and directed consisting essentially of eidetic processing interacting with visual perception, visual motor integration, visual and auditory/sequential/immediate/short term/long term memory, phonological awareness, phonological memory, tracking, vergence, phonics, reading rate, reading accuracy, reading comprehension, phonetic spelling, eidetic spelling, word reading.

8. The method of claim 1, wherein the area of educational therapy and skill being trained, assessed and directed consisting essentially of tracking interacting with visual perception, visual motor integration, visual and auditory/sequential/immediate/short term/long term memory, phonological awareness, phonological memory, eidetic processing, vergence, phonics, reading rate, reading accuracy, reading comprehension, phonetic spelling, eidetic spelling, word reading.

9. The method of claim 1, wherein the area of educational therapy and skill being trained, assessed and directed consisting essentially of vergence interacting with visual perception, visual motor integration, visual and auditory/sequential/immediate/short term/long term memory, phonological awareness, phonological memory, eidetic processing, tracking, phonics, reading rate, reading accuracy, reading comprehension, phonetic spelling, eidetic spelling, word reading.

10. The method of claim 1, wherein the area of educational therapy and skill being trained, assessed and directed consisting essentially of phonics interacting with visual perception, visual motor integration, visual and auditory/sequential/immediate/short term/long term memory, phonological awareness, phonological memory, eidetic processing, tracking, vergence, reading rate, reading accuracy, reading comprehension, phonetic spelling, eidetic spelling, word reading.

11. The method of claim 1, wherein the area of educational therapy and skill being trained, assessed and directed consisting essentially of is reading rate interacting with visual perception, visual motor integration, visual and auditory/sequential/immediate/short term/long term memory, phonological awareness, phonological memory, eidetic processing, tracking, vergence, phonics, reading accuracy, reading comprehension, phonetic spelling, eidetic spelling, word reading.

12. The method of claim 1, wherein the area of educational therapy and skill being trained, assessed and directed consisting essentially of reading accuracy interacting with visual perception, visual motor integration, visual and auditory/sequential/immediate/short term/long term memory, phonological awareness, phonological memory, eidetic processing, tracking, vergence phonics, reading rate, reading comprehension, phonetic spelling, eidetic spelling, word reading.

13. The method of claim 1, wherein the area of educational therapy and skill being trained, assessed and directed consisting essentially of reading comprehension interacting with visual perception, visual motor integration, visual and auditory/sequential/immediate/short term/long term memory, phonological awareness, phonological memory, eidetic processing, tracking, vergence, phonics, reading rate, reading accuracy, phonetic spelling, eidetic spelling, word reading.

14. The method of claim 1, wherein the area of educational therapy and skill being trained, assessed and directed consisting essentially of phonetic spelling interacting with visual perception, visual motor integration, visual and auditory/sequential/immediate/short term/long term memory, phonological awareness, phonological memory, eidetic processing, tracking, vergence, phonics, reading rate, reading accuracy, reading comprehension, eidetic spelling, word reading.

15. The method of claim 1, wherein the area of educational therapy and skill being trained, assessed and directed consisting essentially of eidetic spelling interacting with visual perception, visual motor integration, visual and auditory/sequential/immediate/short term/long term memory, phonological awareness, phonological memory, eidetic processing, tracking, vergence, phonics, reading rate, reading accuracy, reading comprehension, phonetic spelling, word reading.

16. The method of claim 1, wherein the area of educational therapy and skill being trained, assessed and directed consisting essentially of word reading interacting with visual perception, visual motor integration, visual and auditory/sequential/immediate/short term/long term memory, phonological awareness, phonological memory, eidetic processing, tracking, vergence, phonics, reading rate, reading accuracy, reading comprehension, phonetic spelling, eidetic spell.
